(19) United States
(12) Patent Application Publication
(10) Pub. No.: US 2012/0046488 A1
(43) Pub. Date: Feb. 23, 2012

(54) SOLVENTLESS PROCESS TO PRODUCE AROMATIC GROUP-CONTAINING ORGANOSILANES

(75) Inventors: Paul R. Willey, Clifton Park, NY (US); John S. Razzano, Cohoes, NY (US)

(73) Assignee: Momentive Performance Materials Inc., Albany, NY (US)

(21) Appl. No.: 13/211,777

(22) Filed: Aug. 17, 2011

Related U.S. Application Data
(60) Provisional application No. 61/374,662, filed on Aug. 18, 2010.

(51) Int. Cl. C07F 7/08

(52) U.S. Cl. 556/478

(57) ABSTRACT

Disclosed herein is a process for producing an aromatic group-containing organosilane, The process includes reacting a reaction mixture comprising an aromatic organic compound of the formula R¹X and a halosilane or alkoxysilane represented by the formula R²ₐSiZ₄₋ₐ in the presence of magnesium metal in order to produce the organosilane with the proviso that said reaction mixture is essentially free of any organic solvent, wherein R¹ is an aryl group, each R² is independently a phenyl group, a vinyl group or a C1-C4 alkyl group, X is chlorine or bromine, Z is chlorine, bromine or alkoxy, and a has a value of 0, 1, 2, or 3.

### CROSS-REFERENCE TO RELATED APPLICATIONS

This application claims priority to U.S. Provisional Application No. 61/374,662 filed Aug. 18, 2010, which is incorporated herein by reference in its entirety.

### FIELD

The present invention relates to an improved process for producing aromatic group-containing organosilanes and more particularly relates to a solventless process to produce phenyl silanes via a Grignard reaction.

### BACKGROUND

Grignard reaction has been known for decades as an effective way to make organosilanes. Illustratively, U.S. Pat. No. 2,894,012 discloses a process for preparing organosilanes, which includes the steps of: (1) generating an organomagnesium chloride reagent by allowing aryl chloride to react with magnesium in the presence of a heterocyclic compound such as tetrahydrofuran, which according to the patentees acts both as a reaction promoter and a solvent; (2) reacting the organomagnesium chloride reagent with a silicon compound such as organohalosilanes in an inert solvent. This two-step process is cumbersome to carry out in industrial settings.

One step Grignard reactions are well known (Barbier Reaction). However, typically they all require that the Grignard reactions occur in solvents such as anhydrous diethyl ether or tetrahydrofuran, apparently due to the belief that oxygen of these solvents stabilizes the organomagnesium halide reagent generated in the reaction. The presence of these solvents makes the processes more hazardous and expensive than they otherwise might be. Further, as noted by the patentees of U.S. Pat. No. 6,541,651, magnesium salt by-products of the Grignard reaction are quite soluble in ether, and are therefore not easily susceptible to complete removal from the desired product.

To address the problem associated with difficulty of removing magnesium salt by-products such as magnesium chloride, U.S. Pat. No. 6,541,651 discloses utilizing diethyl ether/toluene co-solvent rather than ether alone in the Grignard reaction. Such a process, however, still requires the use of expensive and hazardous solvents.

Attempts have been made to limit the amounts of ethers used in the Grignard reactions. U.S. Pat. No. 4,116,993 discloses a process for producing an aromatic containing silicone compound including reacting an aromatic organic compound of the formula RXₐ with a silicon compound of the formula R_{b}'SiZ_{4-b} in the presence of magnesium and a promoter. Although the patentees describe the process as a solventless one, the requisite amount of THF, which ranges from 0.5 to up to 1 mole per mole of the aromatic compound reactant is not desired, particularly since THF is an organic solvent.

In addition to the problems mentioned above, the commercial importance of the Grignard reaction can also be limited due to the risk of uncontrolled exotherm. It is well known that once the Grignard reactions are initiated, they can be highly exothermic. For a reaction that runs at a commercial scale, uncontrolled exotherm can lead to extreme heat build up and possibly violent explosion.

Accordingly, there is a need to economically produce aromatic containing silanes via a Grignard reaction which does not employ potentially-hazardous organic solvents, which has the capacity for efficient removal of the magnesium salt by-products, and which avoids or minimizes the risk of uncontrolled exotherm. The present invention produces an answer to that need.

### SUMMARY

In one aspect, the present invention relates to a process for producing an organosilane. The process comprises reacting a reaction mixture comprising an aromatic organic compound of the formula R¹X and a halosilane or alkoxysilane represented by the formula R²ₐSiZ₄₋ₐ in the presence of magnesium metal in order to produce the organosilane, with the proviso that the reaction mixture is essentially free of any organic solvent, wherein R¹ is an aryl group, advantageously a C6-C 12 aryl group, each R² is independently a phenyl group, a vinyl group or a C1-C4 alkyl group, X is chlorine or bromine, Z is chlorine, bromine or alkoxy, and a has a value of 0, 1, 2, or 3.

In the case where R¹ is phenyl, X and Z are chlorine, R² is phenyl and a has a value of 1, chlorobenzene and phenyltrichlorosilane are reacted in a 1 to 1 molar ratio, and magnesium is in the form of turnings, 65 to 80% of the silane product is diphenyldichlorosilane. This shows unexpected selectivity for addition of one phenyl group.

The process of the invention avoids using hazardous, expensive solvents, such as diethyl ether and/or tetrahydrofuran, which are commonly used in Grignard reactions heretofore. Further, the process of the invention allows for efficient removal of the magnesium salt by-products. The process of the invention also facilitates mollifying the exothermicity of the Grignard reaction and increasing the yield of the desired products.

### BRIEF DESCRIPTION OF THE DRAWINGS

FIG. 1 illustrates the reaction progress of Example 1.

FIG. 2 illustrates the calculated and measured product distributions of Examples 2-5.

### DETAILED DESCRIPTION

The present invention provides a process to prepare aromatic group-containing organosilanes via a Grignard reaction, wherein the process is carried out without utilizing any solvents. The process comprises reacting a reaction mixture comprising an aromatic organic compound such as an aromatic halide and a halosilane or alkoxysilane in the presence of magnesium metal.

The magnesium metal useful in this invention can be any of the known forms of the metal that are currently used in Grignard-type reactions. For example, the metal can be any of those known in the art that are in the form of turnings, powder, flakes, granules, chips, lumps, and shavings, and the like. It is appreciated that the reaction may be optimized by changing the form of magnesium metal employed in the reaction.

The amount of magnesium metal used in the Grignard reaction is known to a person skilled in the art. Typically, for every mole of aromatic halide used, there is at least one mole of magnesium metal, preferably about 1 to about 1.5 mole, more preferably from about 1 to about 1.2 mole.

The aromatic halide suitable for the process of the invention is represented by formula R¹X wherein R¹ is an aryl, advantageously, a C6-C12 aryl group, and X is chlorine or bromine atom. Exemplary R¹ includes, but is not limited to, phenyl, methylphenyl, ethylphenyl, and naphthyl. Preferably, R¹ is a phenyl group. In one embodiment, the aromatic halide is chlorobenzene.

The halosilane or alkoxysilane useful in this invention are those described by the formula R²ₐSiZ₄₋ₐ, wherein each R² is independently a phenyl group, a vinyl group or a C1-C4 alkyl group such as methyl, ethyl, propyl or butyl, Z is chlorine, bromine or alkoxy, and a has a value of 0, 1, 2 or 3, preferably 1. In one embodiment, R² is a phenyl or a methyl group. The preferred halosilane for the invention is phenyltrichlorosilane.

The ratio of the aromatic halide to the halosilane or alkoxysilane is not strictly limited. A suitable ratio may vary from one reaction to another depending on the chosen reactants and the desired products. In the case of preparing diphenyldichlorosilane from chlorobenzene and phenyltrichlorosilane, the optimal molar ratio range of chlorobenzene to phenyltrichlorosilane is from about 0.5 to about 1.5. Preferably the molar ratio is about 0.9 to 1.1.

According to the invention, the reaction mixture is essentially free of any organic solvents. As used herein, by the term “organic solvents” it is meant any solvents or solvent systems that are normally utilized in the Grignard reactions. As it is used herein, it is appreciated that the organic solvents are inert and do not participate in the Grignard reactions. Exemplary organic solvents include ethers like diethyl ether, tetrahydrofuran, or any co-solvent systems containing ethers. As used herein, “essentially free of any organic solvents” is intended to mean that the reaction mixture does not contain solvent amount or promoter amount of organic solvents, and preferably contains less than 1000 ppm, more preferably zero ppm of organic solvents. Preferably, tetrahydrofuran is not used in the process of the invention for any purpose.

In one embodiment, the reaction mixture consists essentially of an aromatic organic compound, a halosilane or an alkoxysilane and magnesium metal as described above. As used herein, “consisting essentially of” is intended to mean that 95%, preferably 99% of the reaction mixture consists of the aromatic organic compound, the halosilane and the magnesium metal based on the total weight of the reaction mixture.

It should be noted that according to the process of the invention, the Grignard reaction can be carried out at atmospheric pressure or it can be carried out at super atmospheric pressure for example, at 15 to 200 psig. The halosilane or alkoxysilane should be thoroughly mixed with the magnesium metal and the aromatic organic compound. The reaction mixture is suitably heated to a temperature in a range of from about 100° C. to about 220° C., preferably from about 150° C. to about 220° C. In one embodiment, the reaction is carried out in an inert atmosphere. Preferably, the inert atmosphere comprises a nitrogen blanket.

Advantageously, the method for running the reaction is to add all of the silane and magnesium and a portion of the aromatic halide. The amount of aromatic halide can range from 5 to 50% of its total charge. Advantageously, the amount of aromatic halide is 10% of its total charge. The reaction is initiated by heating these contents to about 185 to about 190° C. Once initiation has been verified, the balance of aromatic halide is added at a rate that prevents the exotherm from overheating the mixture. The addition time can be from less than 1 to 36 hours or more. The preferred addition time is from about 8 to about 24 hours. The reaction can also be run by adding all of the reactants and heating for about 10 to about 36 hours provided that the reaction apparatus has sufficient cooling capabilities.

After the reaction has reached completion, according to the process of the invention, the magnesium salts produced as the by-products of the Grignard reaction can simply be removed through filtration. Because no solvent is used in the Grignard reaction, the filtration is readily carried out and the residual amount of the magnesium salts in the filtrate is minimal.

The desired aromatic group-containing organosilanes can be separated out from the reaction mixture by well known distillation procedures. Additional undesired by-products, such as polychlorinated biphenyl compounds (PCBs), if present, may be removed by contacting the product with activated carbon.

It should be noted that the yield of the desired product obtained by the process of the invention is at least 30% and generally may vary anywhere from 60 to 80% or higher depending on the reaction conditions.

The most desirable aromatic-containing silane prepared by the process of the invention is diphenyldichlorosilane obtained from the reaction of chlorobenzene and phenyltrichlorosilane in the presence of magnesium metal without using any solvent such as diethyl ether or tetrahydrofuran. The reaction may be carried out at a temperature of from about 150° C. to about 220° C., at ambient pressure for about 10 to about 36 hours under an inert atmosphere.

The following examples are illustrative and not to be construed as limiting of the invention as disclosed and claimed herein. All parts and percentages are by weight and all temperatures are degrees Celsius unless explicitly stated otherwise.

### EXAMPLES

### Example 1

### Preparation of Diphenyldichlorosilane

A 250 mL three neck roundbottom flask was fitted with a reflux condenser, a nitrogen inlet (bubbler) on top of the condenser, mechanical stirrer and a thermocouple for measuring the reaction temperature. The apparatus was assembled hot and allowed to cool under nitrogen.

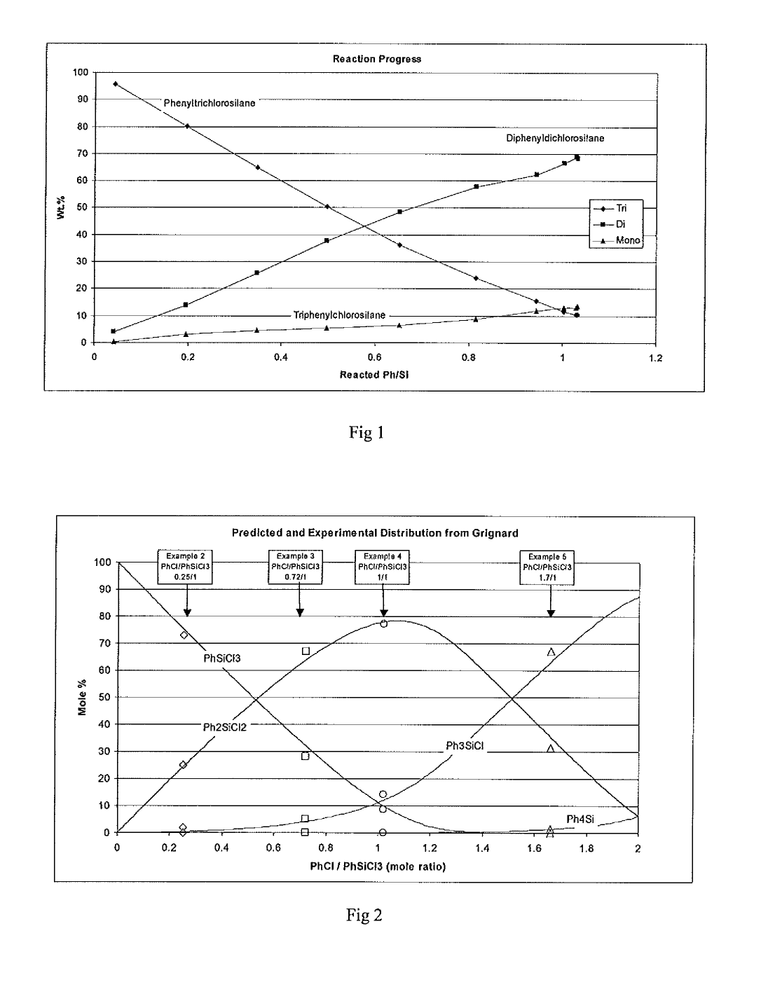

Phenyltrichlorosilane (60.7 grams, 0.28 moles) was transferred into the flask with a dried hypodermic needle and plastic syringe. Chlorobenzene that was stored over activated 3 Å molecular sieves (3.38 grams, 0.030 moles) was added to the flask, followed by magnesium turnings (8.55 g, 0.0.36 moles). The mixture was mechanically stirred and heated to 185° C. (reflux) with a silicone oil bath under slight nitrogen pressure. Roughly 30 minutes after reaching 185° C. the magnesium turnings turned noticeably brown. The balance of the chlorobenzene (28.9 grams, 0.26 mole) was added with a syringe pump over a period of 16 hours while maintaining the temperature at 185° C. The mixture was stirred at 185° C. for one hour after the chlorobenzene add was complete. The reaction progress was monitored by gas chromatography and the results are shown in FIG. 1. The MgCl₂ was a copious brown precipitate in the yellow phenylchlorosilane liquid. The mixture was vacuum filtered through a dried and hot (about 70° C.) Buchner funnel/filter flask. The liquid content was analyzed by gas chromatography and found to be 68% diphenyldichlorosilane.

### Examples 2-5

### Product Distributions at Different Reactant Ratios

Examples 2-5 were conducted in order to understand the product distributions at different PhCl/PhSiCl3 ratios as shown in Table 1. The molar ratios shown are for the actual amount of chlorobenzene that underwent reaction determined by silicon 29 NMR or gas chromatography. This corrects for chlorobenzene that may have escaped from the reaction mixture, been consumed in side reactions and/or been left unreacted. The procedure below is for Example 5. Examples 2-4 were made according to the method of Example 5 but with adjusted reactant amounts (phenyltrichlorosilane, chlorobenzene and magnesium).

A 250 mL three neck roundbottom flask was fitted with a reflux condenser, a nitrogen inlet (bubbler) on top of the condenser, mechanical stirrer and a thermocouple for measuring the reaction temperature. The apparatus was assembled hot and allowed to cool under nitrogen.

Phenyltrichlorosilane (46.5 grams, 0.22 moles) was transferred into the flask with a dried hypodermic needle and plastic syringe. Chlorobenzene that was stored over activated 3 Å molecular sieves (49.5 grams, 0.44 moles) was added to the flask, followed by magnesium turnings (10.7 g, 0.44 moles). The mixture was mechanically stirred and heated at 155° C. overnight with a silicone oil bath under slight nitrogen pressure. The liquid component was isolated by vacuum filtration. The mixture and filtration apparatus was kept warm during filtration. The product distributions for Examples 2-5 are shown in Table 1.

TABLE 1

| | Reactants | | | | |
|---|---|---|---|---|---|
| | (mole ratio) | Products (mole %) | | | |
| Example | PhCl/PhSiCl3 | PhSiCl3 | Ph2SiCl2 | Ph3SiCl | Ph4Si |
| 2 | 0.25 | 73 | 25 | 2 | 0 |
| 3 | 0.72 | 28 | 67 | 5 | 0 |
| 4 | 1.02 | 8.7 | 77.2 | 14.1 | 0 |
| 5 | 1.66 | 0.0 | 31.4 | 67.2 | 1.4 |

Based on the data points generated from examples 2-5, curves were fitted to predict the product distribution at reactant PhCl/PhSiCl₃ ratios ranging from 0 to 2. See FIG. 2. FIG. 2 illustrates that when the molar ratio range of chlorobenzene to phenyl trichlorosilane is from 0.9 to 1.1, the reaction produces optimized amount of diphenyldichlorosilane.

Selectivity to the chlorosilane was assumed to be proportional to the instantaneous chlorosilane concentration times a constant that is proportional to its reactivity (k):

PhMgCl+PhSiCl₃->Ph₂SiCl₂ k1

PhMgCl+Ph₂SiCl₂->Ph₃SiCl k2

PhMgCl+Ph₃SiCl->Ph₄Si k3

Based on the data in FIG. 2, it was calculated that k1, k2 and k3 are 1, 0.1 and 0.003. The relative magnitudes of k1, k2 and k3 show that the reaction of Grignard intermediate phenyl magnesium chloride to form the desired product, Ph₂SiCl₂, under the conditions of the present invention is about 10 times faster than the subsequent reaction to form less desirable components.

While the invention has been described above with references to specific embodiments thereof, it is apparent that many changes, modifications and variations can be made without departing from the inventive concept disclosed herein. Accordingly, it is intended to embrace all such changes, modifications and variations that fall within the spirit and broad scope of the appended claims.

What is claimed is:

1. A process for producing an aromatic group-containing organosilane, the process comprising reacting a reaction mixture comprising an aromatic organic compound of the formula R¹X and a halosilane or alkoxysilane represented by the formula R²ₐSiZ₄₋ₐ in the presence of magnesium metal in order to produce said aromatic group-containing organosilane with the proviso that said reaction mixture is essentially free of any organic solvent, wherein R¹ is an aryl group, each R² is independently a phenyl group, a vinyl group or a C1-C4 alkyl group, X is chlorine or bromine, Z is chlorine, bromine or alkoxy, and a has a value of 0, 1, 2, or 3.

2. The process of claim 1 wherein the process is carried out at a temperature in the range of about 150° C. to about 220° C.

3. The process of claim 1 wherein the process is carried out at a pressure of about ambient to super atmospheric pressure.

4. The process of claim 1 wherein the process is carried out in an inert atmosphere.

5. The process of claim 4 wherein the inert atmosphere is nitrogen.

6. The process of claim 1 wherein said organic solvent is an ether.

7. The process of claim 1 wherein said reaction mixture does not contain tetrahydrofuran.

8. The process of claim 1 wherein R¹ is phenyl.

9. The process of claim 8 wherein the aromatic organic compound is chlorobenzene.

10. The process of claim 1 wherein the halosilane is phenyltrichlorosilane.

11. The process of claim 1 wherein there is present at least one mole of magnesium for every mole of the aromatic organic compound.

12. A process for producing a diphenyldichlorosilane composition, the process comprising reacting a reaction mixture comprising chlorobenzene and phenyltrichlorosilane in the presence of magnesium metal in order to produce the diphenyldichlorosilane composition with the proviso that said reaction mixture is essentially free of any organic solvent.

13. The process of claim 12 wherein the organic solvent is ether.

14. The process of claim 12 wherein the reaction mixture does not contain tetrahydrofuran.

15. The process of claim 12 wherein the process is conducted at a temperature of about 150° C. to about 220° C. for a period of time varying from about 10 to about 36 hours.

16. The process of claim 12 wherein the molar ratio of chlorobenzene relative to phenyltrichlorosilane is from about 0.5 to about 1.5.

17. The process of claim 12 wherein the molar ratio of chlorobenzene relative to phenyltrichlorosilane is about 0.9 to about 1.1.

18. The process of claim 12 further comprising removing the magnesium chloride byproduct from the diphenyldichlorosilane composition by filtration.
